(19) United States
(12) Patent Application Publication
(10) Pub. No.: US 2021/0387440 A1
(43) Pub. Date: Dec. 16, 2021

(54) COMPOUND PADDING WITH GOOD SUPPORT AND COMFORT LAYER

(71) Applicant: ISOTECH HOLDING CORPORATION LLC, Dover, DE (US)

(72) Inventor: Yu-Hsien LEE, Hsinchu City (TW)

(21) Appl. No.: 16/898,797

(22) Filed: Jun. 11, 2020

(51) Int. Cl. B32B 5/18; B32B 7/12; A47C 27/15; B60N 2/70; A47C 7/18

(52) U.S. Cl. CPC B32B 5/18; B32B 7/12; A47C 27/15; B60N 2/7017; A47C 7/18; B32B 2479/00; B60N 2/80; B32B 2605/003; B32B 2250/40; B32B 2307/72; B32B 2307/728; B32B 2305/022; B32B 2266/0278

(57) ABSTRACT

Compound padding having comfort layer and providing good support is revealed. The compound padding includes a support layer and at least one comfort layer. The support layer is a foam layer made of low-density melamine resin foam with certain support while the comfort layer is a foam layer made of hydrophilic polyurethane foam and attached to at least one surface of the support layer by an adhesive layer. Thereby the compound padding can provide effective support to user's body by the support layer and gives a good feeling and a sense of comfort to users by the comfort layer when users' skin is in contact with the compound padding. The compound padding has the advantages of low density, light weight and reduced cost.

### BACKGROUND OF THE INVENTION

The present invention relates to padding, especially to compound padding composed of a foam layer made of melamine resin foam and a foam layer made of hydrophilic polyurethane foam adhered and connected to each other.

Generally, various types of soft cushions/padding which users' body is lying on, such as mattresses, soft cushions, car seat padding, seat padding of a public transport vehicle, etc. are available on the market now. The main function/use of the cushion/padding is not only to provide sufficient support to user's body but also to provide a good feeling and a sense of comfort to user's body. However, the soft cushion/padding uses conventional techniques or materials available now to produce a support layer. Take a mattress as an example. A good mattress should provide effective support to the respective parts of the body while the user is lying on the mattress. The insufficient support may result in sagging or misalignment of the spine and other body parts and users may feel uncomfortable. Most of the mattresses use a plurality of spring supports or drum supports constructed by metal parts mounted inside the mattress for providing effective support. Yet the total weight of the mattress with the support layer formed by the spring supports or drum supports is too much and the production cost of the mattress is also quite high. This will reduce the competitiveness of manufacturers. The efficiency of use at the user end is also affected. For example, users are unable to move the mattress easily for changing bed sheets or doing other cleaning jobs once the mattress is too heavy.

### SUMMARY OF THE INVENTION

Therefor it is a primary object of the present invention to provide compound padding having comfort layer and providing good support with features of low density, light weight and reduced production cost. The compound padding includes a support layer and at least one comfort layer. The support layer is a foam layer made of low-density melamine resin foam with certain support while the comfort layer is a foam layer made of hydrophilic polyurethane. The comfort layer is attached to one surface of the support layer by an adhesive layer. The compound padding not only provides effective support to user's body by the support layer but also provides a good feeling and a sense of comfort to user's body by the comfort layer while skin on every part of the user's body is in contact with the compound padding.

In order to achieve the above object, compound padding having comfort and providing good support according to the present invention includes a support layer and at least one comfort layer. The support layer is formed by a foam layer made of low-density melamine resin foam with certain support. By the support layer, the compound padding provides good support to user's body. The respective comfort layers are made of hydrophilic polyurethane foam. The comfort layer is adhered to the surface of the support layer by an adhesive layer. The compound padding provides a good feeling and a sense of comfort to user's body by the comfort layer while skin on every part of the user's body is in contact with the compound padding. The compound padding has the advantages of low density, light weight and reduced cost.

Preferably, the density of the support layer is from 7 kg/m³ to 30 kg/m³.

Preferably, the hydrophilic polyurethane foam of the comfort layer is mainly composed of 40 to 60 parts by weight of hydrophilic polyurethane prepolymer, 10 to 20 parts by weight of acrylic emulsion polymer, and 5 to 20 parts by weight of polyether polyol. The polyether polyol consists of water, surfactant, and ammonia catalyst mixed in a certain ratio. The hydrophilic polyurethane prepolymer is composed of 40-70 wt % polyether polyol and 30-60 wt % isocyanate. The molecular weight of polyether polyol contained in hydrophilic polyurethane is from 50 to 2000 while polyether polyol includes at least 40 mole % ether groups (-EO-) and the amount of ether groups (-EO-) is 20-99.9 wt %. The whole comfort layer is produced by foam molding and using carbon dioxide (CO2) generated by the water-isocyanate reaction as a blowing agent.

Preferably, the compound padding further includes an outer protective layer covering the support layer and the respective comfort layers. The outer protective layer has a first side surface and a second side surface opposite to each other.

Preferably, the compound padding further includes a mattress, a sofa cushion, car seat padding, and seat padding of a public transport vehicle.

Preferably, the comfort layer is attached to an upper surface of the support layer by the adhesive layer or the comfort layers are attached to the upper surface and the lower surface of the support layer correspondingly by the respective adhesive layers when the compound padding is used as the mattress.

Preferably, the thickness of the support layer is from 15 centimeters to 25 centimeters (cm) while the thickness of the respective comfort layers is from 3 cm to 7 cm when the compound padding is used as the mattress.

Preferably, the sofa cushion further includes at least one sofa seat cushion, at least one sofa back cushion, and at least one sofa pillow when the compound padding is used as the sofa cushion.

Preferably, the car seat padding further includes base padding, backrest padding, and headrest padding when the compound padding is used as the car seat padding.

### BRIEF DESCRIPTION OF THE DRAWINGS

FIG. 1 is a perspective view of an embodiment used as a mattress according to the present invention;

FIG. 2 is an explosive view of the embodiment in use in FIG. 1 according to the present invention;

FIG. 3 is a partial enlarged side view of a section of the embodiment in FIG. 2 according to the present invention;

FIG. 4 is a perspective view of an embodiment used as sofa cushions according to the present invention;

FIG. 5 is an explosive view of the embodiment in FIG. 4 according to the present invention;

FIG. 6 is a partial enlarged side view of a sofa seat cushion of the embodiment in FIG. 5 according to the present invention;

FIG. 7 is a partial enlarged side view of a sofa back cushion of the embodiment in FIG. 5 according to the present invention;

FIG. 8 is a partial enlarged side view of a sofa pillow of the embodiment in FIG. 5 according to the present invention;

FIG. 9 is a perspective view of an embodiment used as car seat padding according to the present invention;

FIG. 10 is an explosive view of the embodiment in FIG. 9 according to the present invention;

FIG. 11 is a partial enlarged side view of base padding and backrest padding of the embodiment in FIG. 10 according to the present invention;

FIG. 12 is a partial enlarged side view of headrest padding of the embodiment in FIG. 10 according to the present invention;

FIG. 13 is a perspective view of an embodiment used as seat padding of a public transport vehicle according to the present invention;

FIG. 14 is an explosive view of the embodiment in FIG. 13 according to the present invention;

FIG. 15 is a partial enlarged side view of the embodiment used as seat padding of a public transport vehicle in FIG. 14 according to the present invention.

### DETAILED DESCRIPTION OF THE PREFERRED EMBODIMENTS

The structure and technical features of the present invention are described in details as follows with reference to the related figures. The figures are not drawn to scale. The figures are provided for the purpose of illustrating structure and functions of the present invention, and not used to limit the scope of the present invention.

Refer to FIG. 3, compound padding 1 having comfort layer and providing good support according to the present invention includes a support layer 10 and at least one comfort layer 20.

The support layer 10 is formed by a foam layer made of low-density melamine resin foam (MF foam) with certain support. In the present invention, the support layer 10 is used to replace spring supports or drum supports which are constructed by metal parts and used in paddings available now (such as mattresses). Thus the compound padding 1 can provide effective support to user's body by the support layer 10. Melamine Resin itself is a kind of synthetic resin and thermosetting polymer with certain heat resistance, anti-corrosion property and heat insulation property. Thus the safety of the compound padding 1 for home use is further improved. Moreover, the optimal density of the support layer 10 is ranging from 7 kg/m³ to 30 kg/m³.

Each of the respective comfort layers 20 is formed by a foam layer made of hydrophilic polyurethane foam. The comfort layer 20 is attached to the surface of the support layer 10 by an adhesive layer 30. The compound padding 1 provides a good feeling and a sense of comfort to user's body by the comfort layer 20 while skin on every part of the user's body is in contact with the compound padding 1. The foam layer made of hydrophilic polyurethane has multiple functions including shock absorption, average pressure release property, moisture absorption, and thermo absorption. Thus even the skin on different parts of user′ body have contacted with the comfort layer 20 for a long period of time (such as during sleep), the user still feels comfortable and stay dry (due to moisture absorption) and cool (due to thermo absorption) all the time.

In order to improve the comfort feeling of user's body provided by the comfort layer 20, the hydrophilic polyurethane of the comfort layer 2 is mainly composed of 40 to 60 parts by weight of hydrophilic polyurethane prepolymer, 10 to 20 parts by weight of acrylic emulsion polymer and 5 to 20 parts by weight of polyether polyol. The polyether polyol consists of water, surfactant, and ammonia catalyst mixed in a certain ratio. The hydrophilic polyurethane prepolymer is composed of 40-70 wt % (weight percent) polyether polyol and 30-60 wt % isocyanate. The molecular weight of polyether polyol contained in hydrophilic polyurethane is from 50 to 2000 while polyether polyol includes at least 40 mole % ether groups (-EO-) and the amount of ether groups (-EO-) is 20-99.9%. The whole comfort layer 2 is produced by foam molding and using carbon dioxide (CO2) generated by the water-isocyanate reaction as a blowing agent.

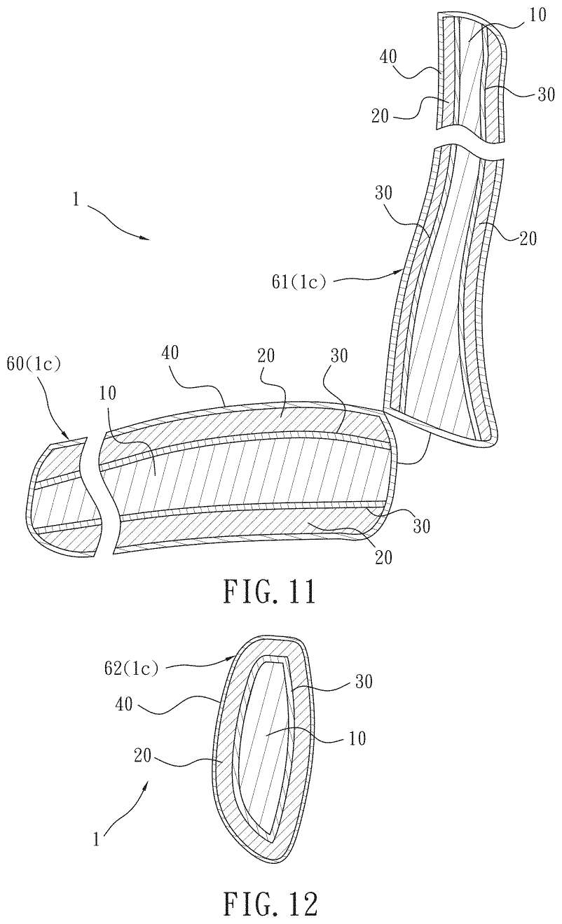

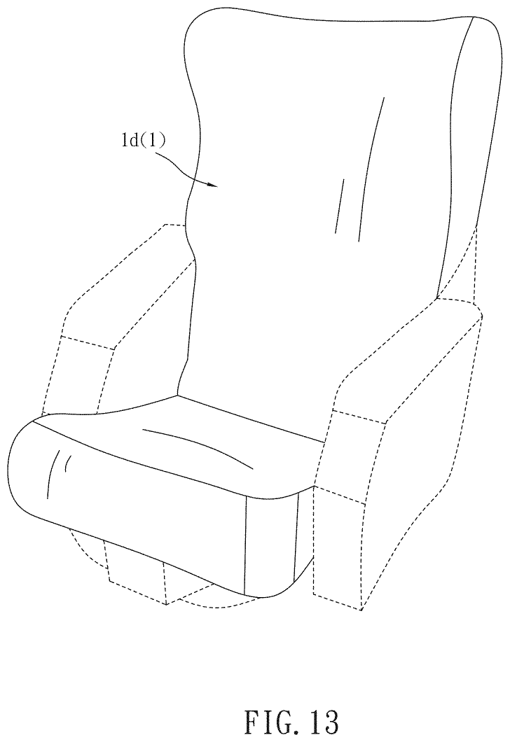

Refer to FIG. 8, FIG. 11, and FIG. 12, the compound padding 1 further includes an outer protective layer 40 covering the support layer 10 and the respective comfort layers 20. The outer protective layer 40 composed of a first side surface 41 and a second side surface 42 opposite to each other is used for protecting the compound padding 1 from dirt and stains.

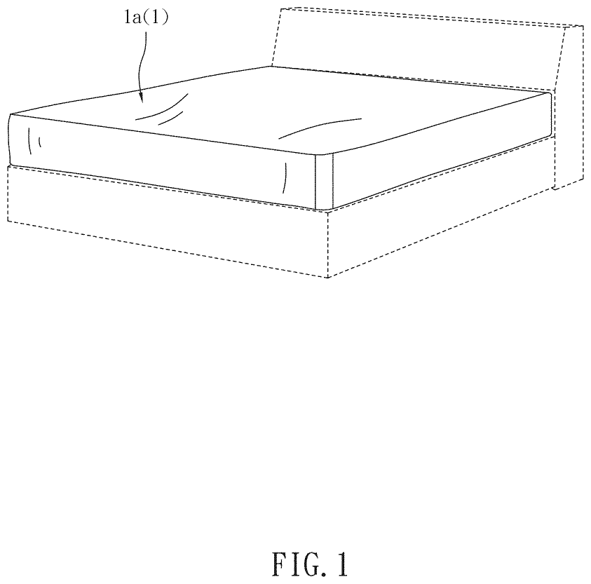

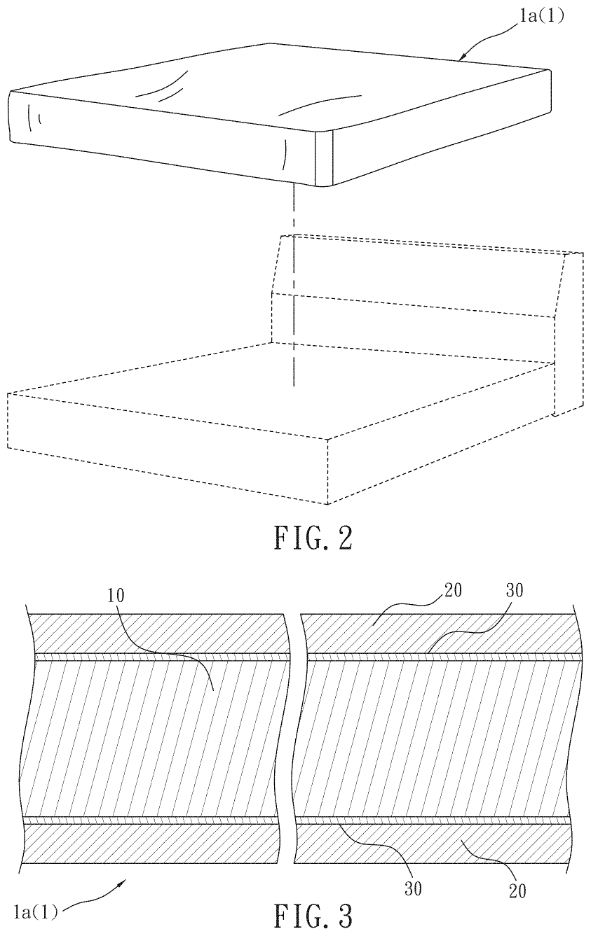

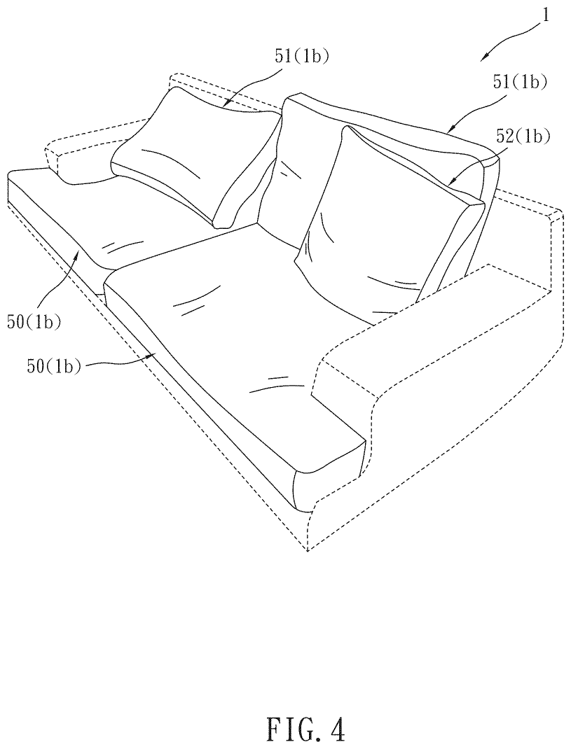

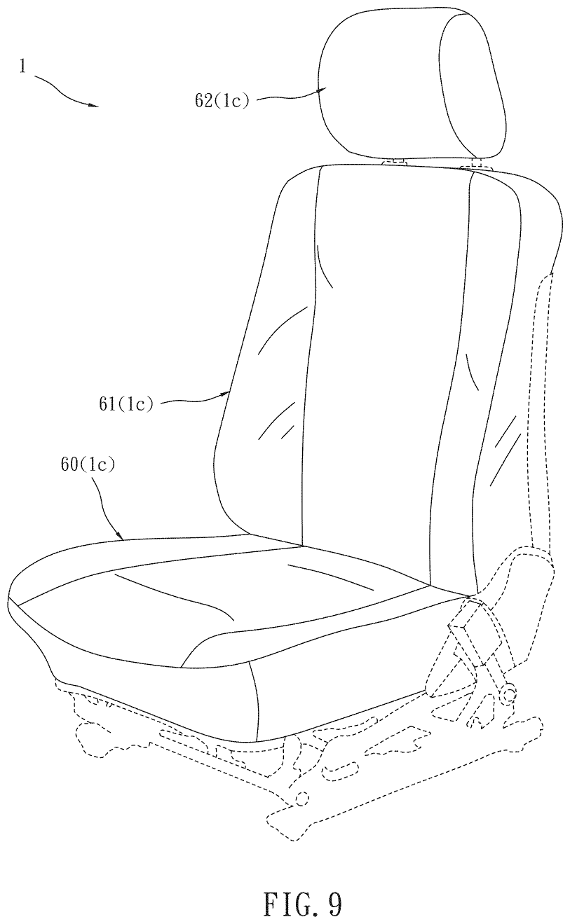

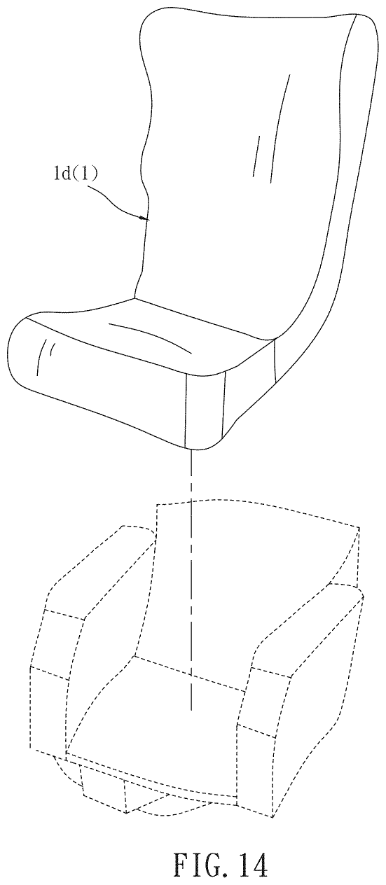

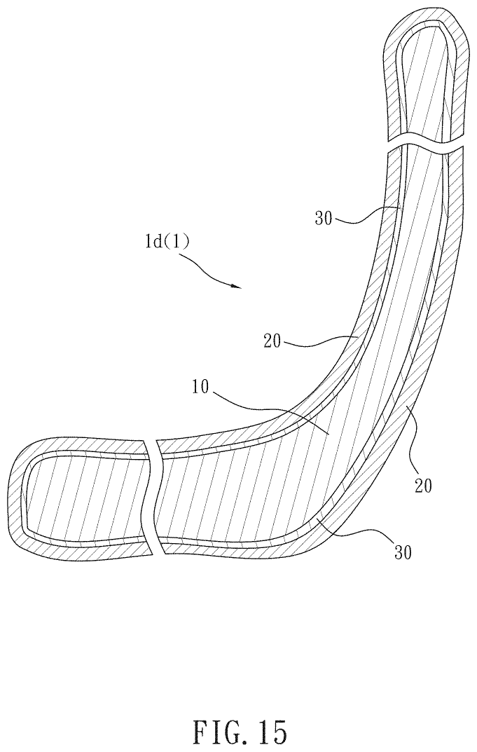

Refer to FIG. 1, FIG. 4, FIG. 9, and FIG. 13, the compound padding 1 further includes a mattress 1a (as shown in FIG. 1-3), a sofa cushion 1b (as shown in FIG. 4-8), car seat padding 1c (as shown in FIG. 9-12), and seat padding of a public transport vehicle 1d (as shown in FIG. 13-15).

Refer to FIG. 1-3, when the compound padding 1 is used as the mattress 1a, the comfort layer 20 is attached to an upper surface of the support layer 10 by the adhesive layer 30 or the two comfort layers 20 are attached to the upper surface and the lower surface of the support layer 10 correspondingly by the respective adhesive layers 30. The support layer 10 of the present invention is used to replace metal parts such as spring supports or drum supports commonly used in the mattress available now. The cost of the material for the support layer 10 is lower than the cost of the spring supports or the drum supports. Thus the production cost or selling price can be reduced dramatically. The weight of the material for the support layer 10 is also lighter than that the weight of the material for the spring supports or the drum supports. Thereby users can transport the mattress 1a more easily and conveniently.

While manufacturing the mattress 1a, the thickness of the support layer 10 can be set to range from 15 centimeters (cm) to 25 cm while the thickness of the respective comfort layers 20 is from 3 cm to 7 cm.

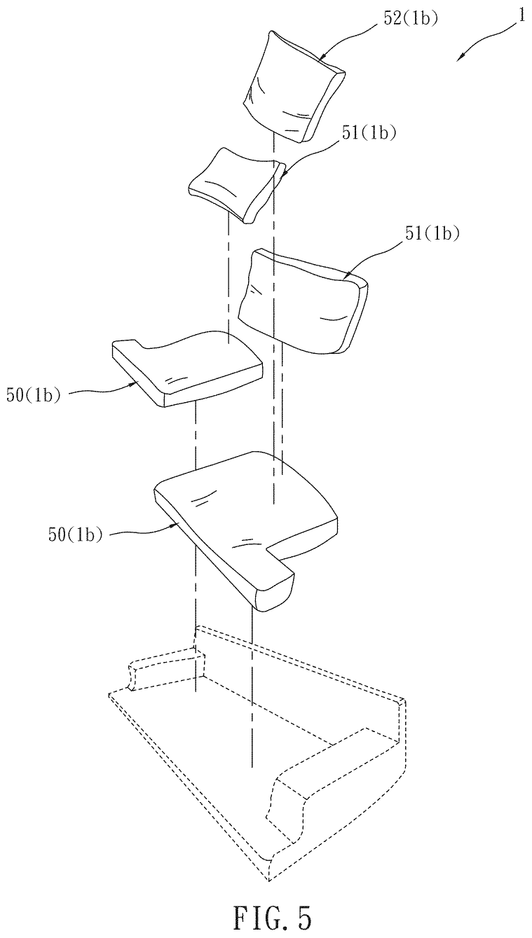

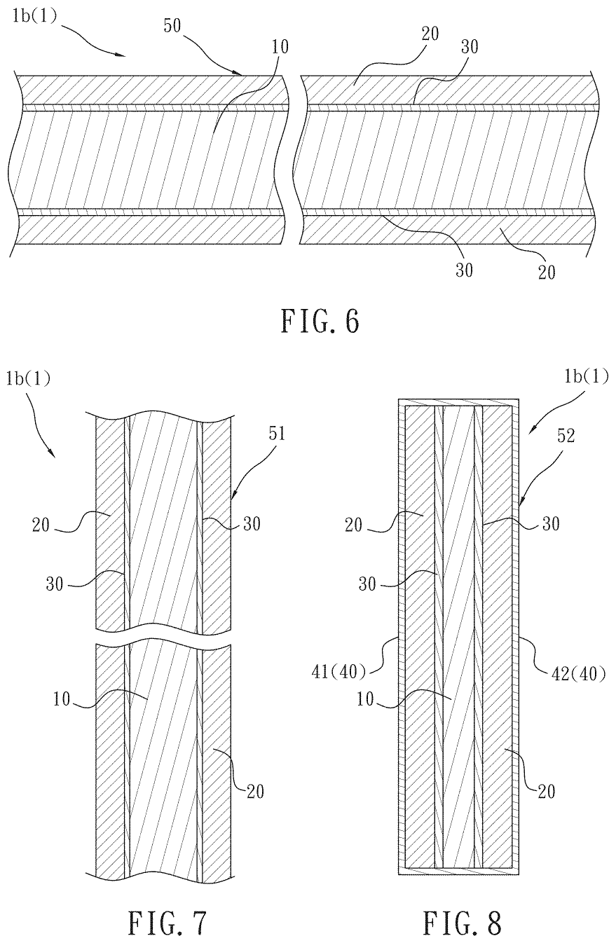

Refer to FIG. 4-8, the sofa cushion 1b further includes sofa seat cushions 50 (as shown in FIG. 5 and FIG. 6), sofa back cushions 51 (as shown in FIG. 5 and FIG. 7), and a sofa pillow 52 (as shown in FIG. 5 and FIG. 8) when the compound padding 1 is used as the sofa cushion 1b. The materials for the support layer 10 of the sofa cushion 1b have features of heat resistance, anti-corrosion property and heat insulation property (not combustion supporting). Thus the safety of the sofa cushion 1b for home use is further improved. Moreover, the sofa pillow 52 further includes an outer protective layer 40 arranged at an outer surface of the sofa pillow 52 to protect against dirt and stains or enhance the aesthetics.

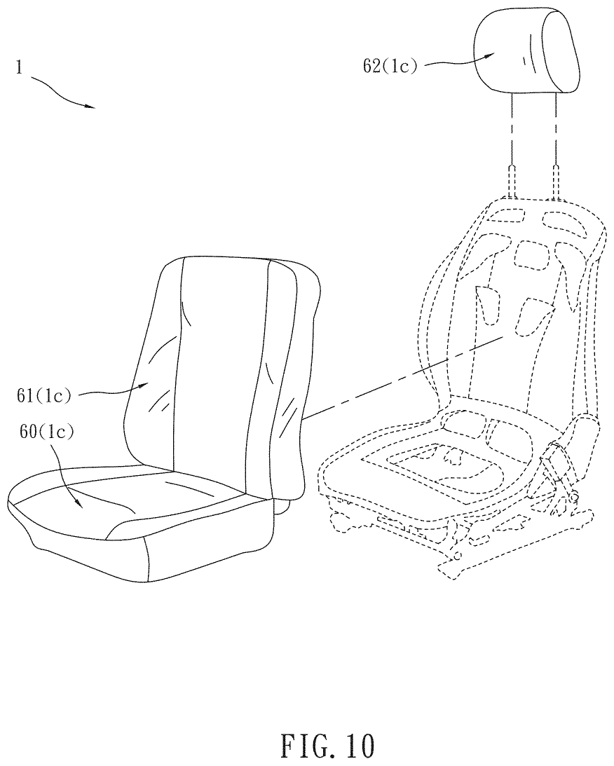

Refer to FIG. 9-12, the car seat padding 1c further includes base padding 60 (as shown in FIG. 10 and FIG. 11), backrest padding 61 (as shown in FIG. 10 and FIG. 11), and headrest padding 62 (as shown in FIG. 10 and FIG. 12) when the compound padding 1 is used as the car seat padding 1c. The support layer 10 of the sofa cushion 1b has heat resistance, anti-corrosion property and heat insulation property (not combustion supporting). Thus the safety of the car seat padding 1c for home use is further improved. Moreover, an outer protective layer 40 covers a surface of the seat cushion 60, the back cushion 61, and the headrest padding 62 to keep them clean all the time or improve the aesthetics.

Furthermore, the compound padding 1 can be applied to seat padding of a public transport vehicle 1d, as shown in FIG. 13-15.

In summary, the present compound padding 1 has the following advantages compared with the similar paddings in the filed:

(1) The support layer 10 of the present invention is a foam layer made of low-density melamine resin foam with certain support. Thus the compound padding 1 of the present invention has the advantages of low density, light weight and reduced cost (compared with spring supports or drum supports used before).
(2) The comfort layer 20 of the present invention is a foam layer made of hydrophilic polyurethane foam. Thereby compound padding 1 of the present invention provides moisture absorption and thermo absorption functions to user's body to make the user stay dry and cool and thus have a comfortable feeling while the user is in contact with the compound padding 1 for a long period of time (such as during sleep).

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. Compound padding having comfort layer and providing good support comprising:
a support layer which is a foam layer made of low-density melamine resin foam with certain support so that the compound padding is able to provide effective support to user's body by the support layer; and
at least one comfort layer which is a foam layer made of hydrophilic polyurethane foam while the comfort layer is attached to at least one surface of the support layer by an adhesive layer so that the compound padding provides a good feeling and a sense of comfort to the user's body by the comfort layer when skin of the user's body is in contact with the compound padding.

2. The compound padding as claimed in claim 1, wherein density of the support layer is from 7 kg/m³ to 30 kg/m³.

3. The compound padding as claimed in claim 1, wherein the hydrophilic polyurethane foam of the comfort layer includes 40 to 60 parts by weight of hydrophilic polyurethane prepolymer, 10 to 20 parts by weight of acrylic emulsion polymer, and 5 to 20 parts by weight of polyether polyol; the polyether polyol includes water, surfactant, and ammonia catalyst mixed in a certain ratio; the hydrophilic polyurethane prepolymer includes 40-70 wt % (weight percent) polyether polyol and 30-60 wt % isocyanate; molecular weight of polyether polyol included in hydrophilic polyurethane is from 50 to 2000 while the polyether polyol includes at least 40 mole % (mole percent) ether groups (-EO-) and the amount of ether groups (-EO-) is 20-99.9 wt %; the comfort layer is produced by foam molding and using carbon dioxide (CO2) generated by the water-isocyanate reaction as a blowing agent.

4. The compound padding as claimed in claim 1, wherein the compound padding further includes an outer protective layer covering the support layer and the comfort layer.

5. The compound padding as claimed in claim 1, wherein the compound padding further includes a mattress, a sofa cushion, car seat padding, and seat padding of a public transport vehicle.

6. The compound padding as claimed in claim 5, wherein the comfort layer is attached to an upper surface of the support layer by the adhesive layer when the compound padding is used as the mattress.

7. The compound padding as claimed in claim 5, wherein the comfort layers are attached to an upper surface and a lower surface of the support layer correspondingly by the respective adhesive layers when the compound padding is used as the mattress.

8. The compound padding as claimed in claim 5, wherein thickness of the support layer is from 15 cm to 25 cm while thickness of the respective comfort layers is from 3 cm to 7 cm when the compound padding is used as the mattress.

9. The compound padding as claimed in claim 5, wherein the sofa cushion further includes at least one sofa seat cushion, at least one sofa back cushion, and at least one sofa pillow when the compound padding is used as the sofa cushion.

10. The compound padding as claimed in claim 5, wherein the car seat padding further includes base padding, backrest padding, and headrest padding when the compound padding is used as the car seat padding.
